(19) United States
(12) Patent Application Publication
(10) Pub. No.: US 2021/0164848 A1
(43) Pub. Date: Jun. 3, 2021

(54) TEMPERATURE SENSOR DEVICE

(71) Applicant: Murata Manufacturing Co., Ltd., Nagaokakyo-shi (JP)

(72) Inventor: Koichi Yamada, Nagaokakyo-shi (JP)

(21) Appl. No.: 17/176,443

(22) Filed: Feb. 16, 2021

Related U.S. Application Data
(63) Continuation of application No. PCT/JP2019/038255, filed on Sep. 27, 2019.

(30) Foreign Application Priority Data
Oct. 12, 2018 (JP) 2018-193062

(51) Int. Cl. G01K 7/22; H01C 1/14; H01C 7/00

(52) U.S. Cl. CPC G01K 7/223; H01C 7/008; H01C 1/14

(57) ABSTRACT

A plurality of temperature sensors are disposed on a substrate and spaced from each other on a plurality of concentric virtual rings. The plurality of temperature sensors are each connected to one of a plurality of first common lines and one of a plurality of second common lines. The plurality of first common lines each include a first annular line portion located along the plurality of virtual rings, and a first connection line portion connecting the first annular line portion to at least one of the plurality of temperature sensors. The first annular line portion of each of the plurality of first common lines is located on an outer side of the plurality of virtual rings.

### CROSS REFERENCE TO RELATED APPLICATIONS

This application is a continuation of International Application No. PCT/JP2019/038255, filed Sep. 27, 2019, which claims priority to Japanese Patent Application No. 2018-193062, filed Oct. 12, 2018, the entire contents of each of which are hereby incorporated in their entirety.

### TECHNICAL FIELD

Aspects of the present disclosure are directed to a temperature sensor device and a method for manufacturing the temperature sensor device.

### BACKGROUND OF THE INVENTION

In recent years, some examples of configurations of temperature sensor devices have been disclosed. For example, Japanese Unexamined Patent Application Publication No. 5-52666 (“JP '666”). The temperature sensor device described in JP '666 is formed by an array of resistance thermometers connected in a planar grid form. In the temperature sensor device, the resistance thermometers arranged in a planar grid form are connected to intersecting lead wires extending in longitudinal and transverse directions to form sensors.

### SUMMARY OF THE INVENTION

When a temperature distribution concentrically spreading from a heat source is to be measured using a temperature sensor device where common lines connected to a plurality of temperature sensors intersect and extend in longitudinal and transverse directions, since the common lines cannot be placed in the center of the temperature sensor device where the heat source is placed, the common lines need to be arranged in such a manner as to avoid the center of the temperature sensor device. Since the temperature sensors cannot be placed near the heat source in this case, the temperature near the heat source cannot be measured. This affects accuracy in measuring the temperature distribution.

The present invention has been made in view of the problem described above. An object of the present invention is to provide a temperature sensor device that is capable of measuring a concentric temperature distribution with high accuracy.

Accordingly, it is an object of the present disclosure to provide a temperature sensor device which may include a substrate, a plurality of temperature sensors, a plurality of first common lines, and a plurality of second common lines. The plurality of temperature sensors are disposed on the substrate and spaced from each other on a plurality of concentric virtual rings. The plurality of first common lines may be connected to the plurality of temperature sensors from an outer side of the plurality of virtual rings. The plurality of second common lines may be connected to the plurality of temperature sensors from an inner side of the plurality of virtual rings. The plurality of temperature sensors are each connected to one of the plurality of first common lines and one of the plurality of second common lines. The plurality of first common lines each include a first annular line portion located along the plurality of virtual rings, and a first connection line portion connecting the first annular line portion to at least one of the plurality of temperature sensors. The first annular line portion of each of the plurality of first common lines is located on the outer side of the plurality of virtual rings.

According to an object of the present disclosure, a temperature sensor device may enable accurate measurement of a concentric temperature distribution.

Additional advantages and novel features of the system of the present disclosure will be set forth in part in the description that follows, and in part will become more apparent to those skilled in the art upon examination of the following or upon learning by practice of the disclosure.

### BRIEF DESCRIPTION OF THE DRAWINGS

In the descriptions that follow, like parts are marked throughout the specification and drawings with the same numerals, respectively. The drawings are not necessarily drawn to scale and certain drawings may be shown in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is a plan view of a temperature sensor device in accordance with aspects of the present disclosure;

FIG. 2 is a plan view illustrating an arrangement of temperature sensors in the temperature sensor device illustrated in FIG. 1.

FIG. 3 is an enlarged plan view of region III surrounded by a dotted line in the temperature sensor device illustrated in FIG. 1;

FIG. 4 is an enlarged plan view of region IV surrounded by a dotted line in the temperature sensor device illustrated in FIG. 1;

FIG. 5 is an enlarged plan view of region V surrounded by a dotted line in the temperature sensor device illustrated in FIG. 1;

FIG. 6 is an enlarged plan view of region VI surrounded by a dotted line in the temperature sensor device illustrated in FIG. 1;

FIG. 7 is a circuit diagram illustrating how a plurality of temperature sensors are each electrically connected to one of a plurality of first common lines and one of a plurality of second common lines in the temperature sensor device in accordance with aspects of the present disclosure;

FIG. 8 is a plan view of a temperature sensor device in accordance with aspects of the present disclosure;

FIG. 9 is a plan view illustrating an arrangement of temperature sensors in the temperature sensor device illustrated in FIG. 8;

FIG. 10 is an enlarged plan view of region X surrounded by a dotted line in the temperature sensor device illustrated in FIG. 8;

FIG. 11 is an enlarged plan view of region XI surrounded by a dotted line in the temperature sensor device illustrated in FIG. 8;

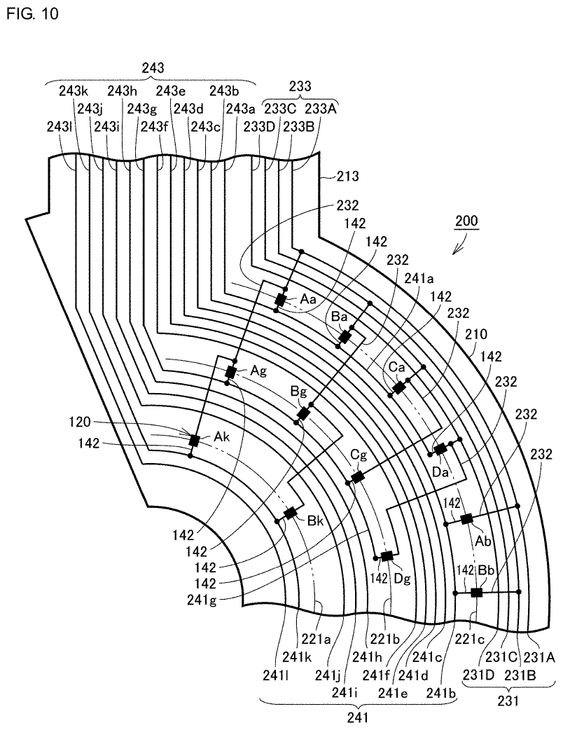

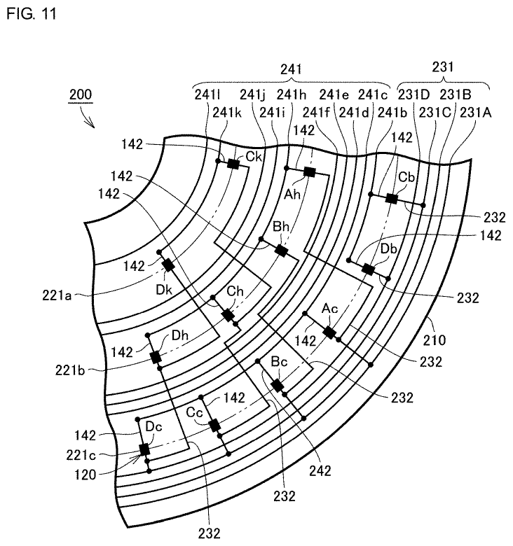

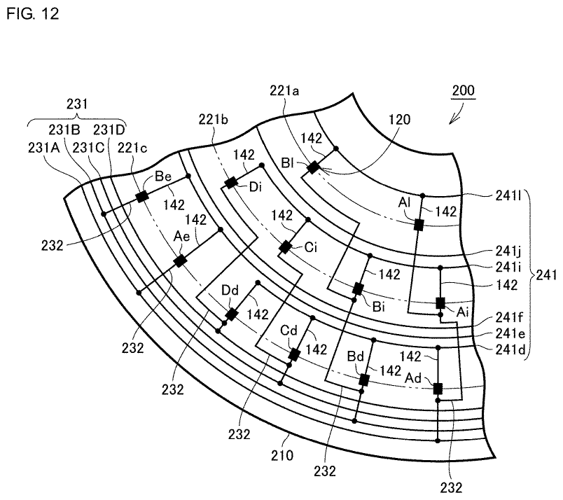

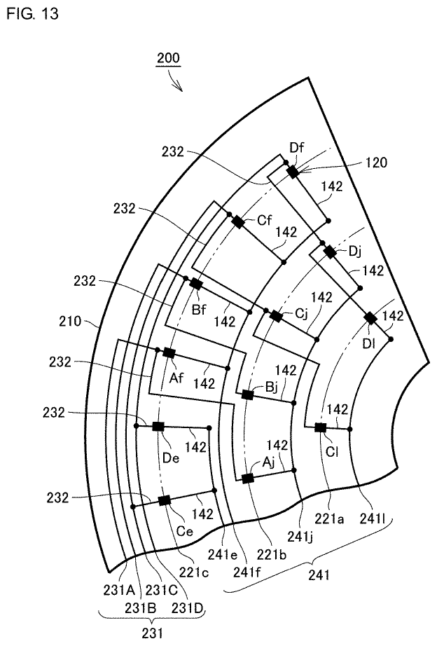

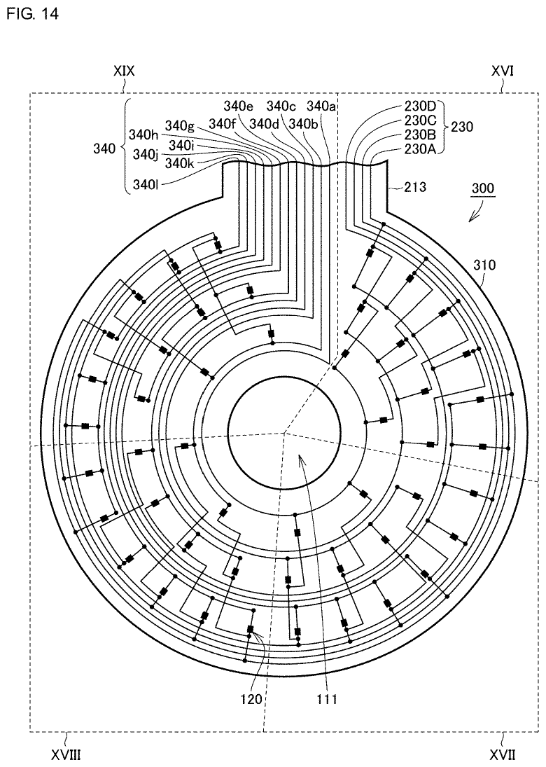

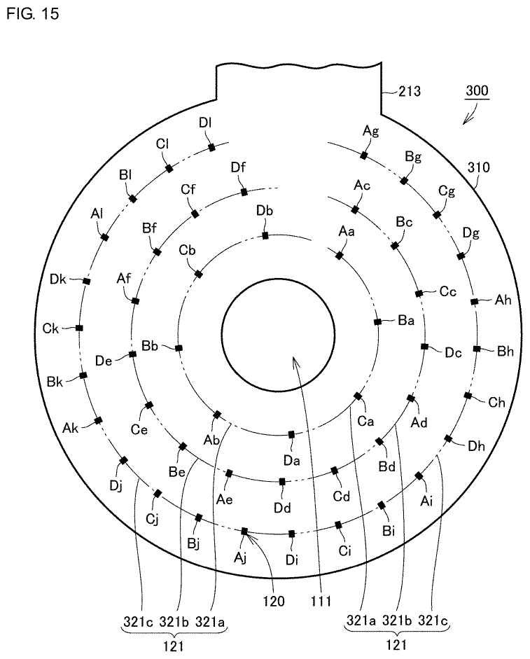

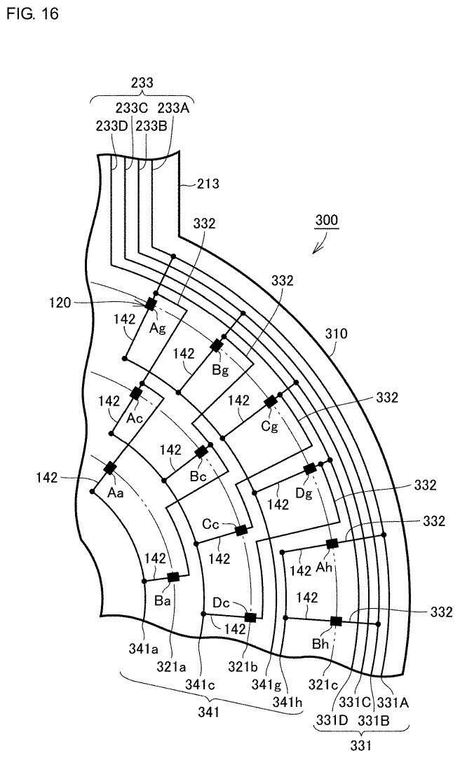

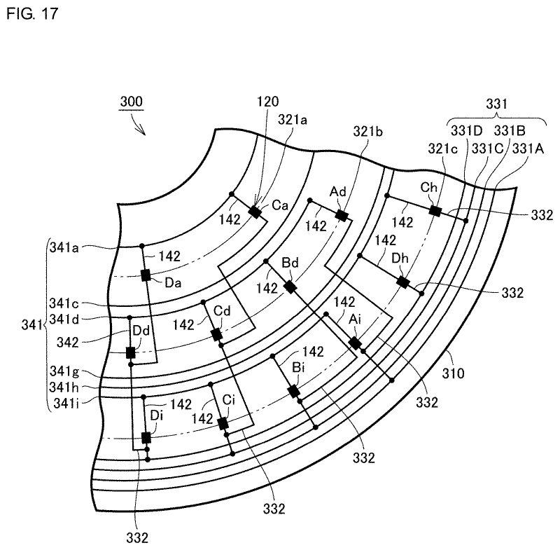

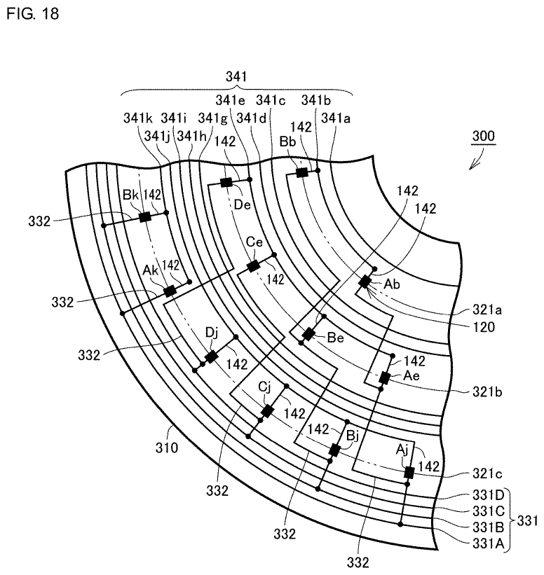

FIG. 10 is an enlarged plan view of region X surrounded by a dotted line in the temperature sensor device illustrated in FIG. 8;

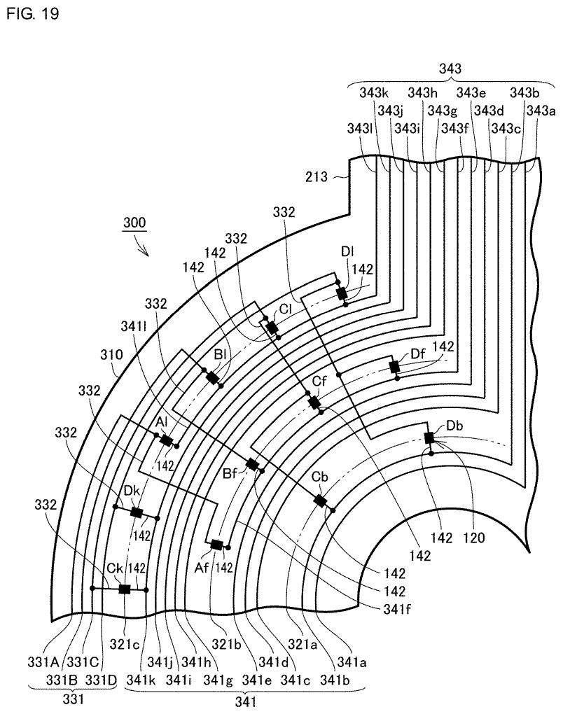

FIG. 11 is an enlarged plan view of region XI surrounded by a dotted line in the temperature sensor device illustrated in FIG. 8;

FIG. 12 is an enlarged plan view of region XII surrounded by a dotted line in the temperature sensor device illustrated in FIG. 8;

FIG. 13 is an enlarged plan view of region XIII surrounded by a dotted line in the temperature sensor device illustrated in FIG. 8;

FIG. 14 is a plan view of a temperature sensor device in accordance with aspects of the present disclosure;

FIG. 15 is a plan view illustrating an arrangement of temperature sensors in the temperature sensor device illustrated in FIG. 14;

FIG. 16 is an enlarged plan view of region XVI surrounded by a dotted line in the temperature sensor device illustrated in FIG. 14;

FIG. 17 is an enlarged plan view of region XVII surrounded by a dotted line in the temperature sensor device illustrated in FIG. 14;

FIG. 18 is an enlarged plan view of region XVIII surrounded by a dotted line in the temperature sensor device illustrated in FIG. 14; and

FIG. 19 is an enlarged plan view of region XIX surrounded by a dotted line in the temperature sensor device illustrated in FIG. 14.

### DETAILED DESCRIPTION

A temperature sensor device according to aspects of the present disclosure will be described with reference to the drawings. In the following description of aspects of the present disclosure, the same or corresponding parts throughout the drawings are denoted by the same reference numerals and their description will not be repeated.

However, the present disclosure is not limited to the following configurations, and can be appropriately modified and applied without changing the gist of the present disclosure. Note that a combination of two or more of individual desirable configurations of the present disclosure described below is also the present invention.

Aspects of the disclosure described below are mere examples, and the configurations can be partially replaced or combined in the different aspects of the disclosure. The description of items common to different aspects will be omitted, and different points will be described. In particular, the same effects by the same configuration will not be sequentially referred to for each aspect.

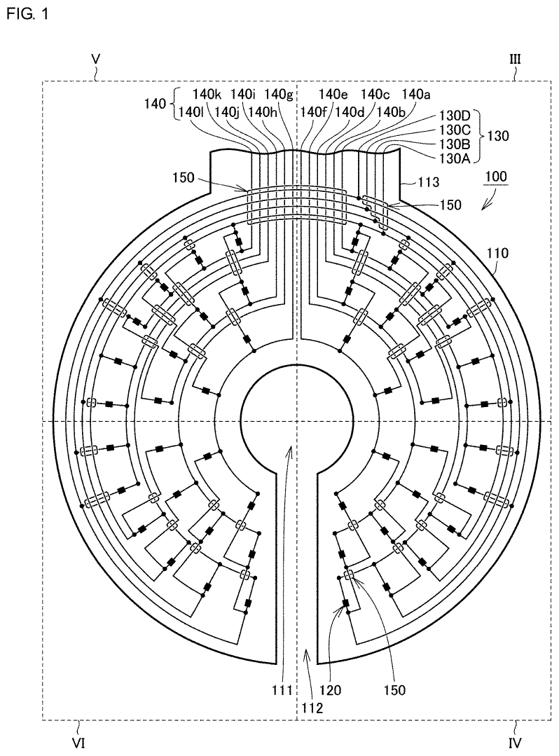

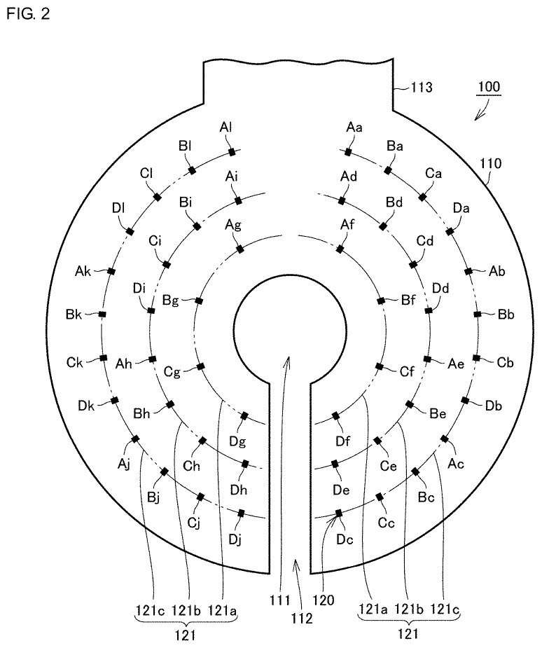

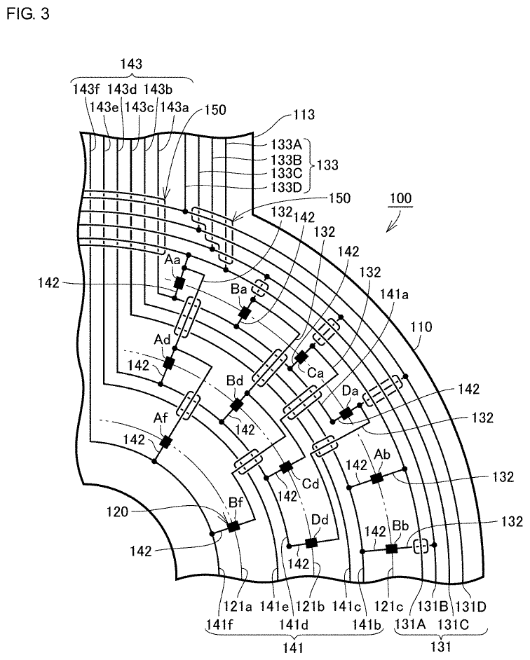

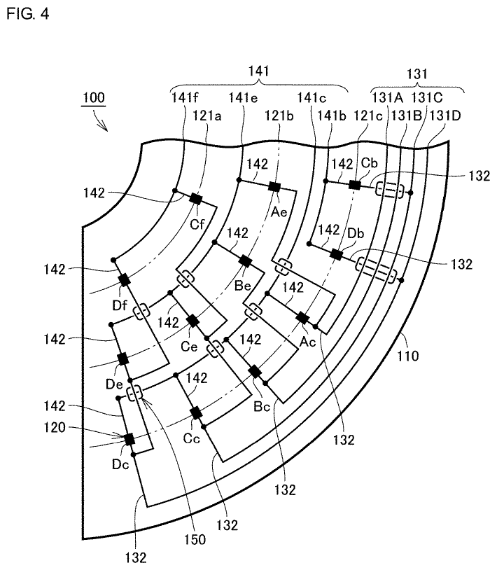

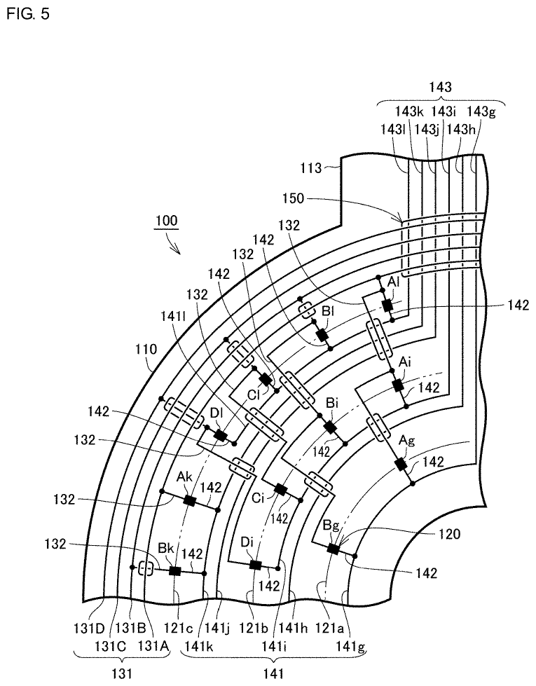

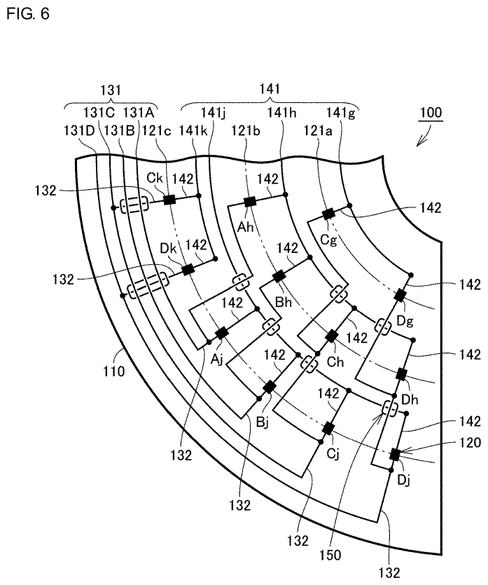

FIG. 1 is a plan view of a temperature sensor device in accordance with aspects of the present disclosure. FIG. 2 is a plan view illustrating an arrangement of temperature sensors in the temperature sensor device illustrated in FIG. 1. FIG. 3 is an enlarged plan view of region III surrounded by a dotted line in the temperature sensor device illustrated in FIG. 1. FIG. 4 is an enlarged plan view of region IV surrounded by a dotted line in the temperature sensor device illustrated in FIG. 1. FIG. 5 is an enlarged plan view of region V surrounded by a dotted line in the temperature sensor device illustrated in FIG. 1. FIG. 6 is an enlarged plan view of region VI surrounded by a dotted line in the temperature sensor device illustrated in FIG. 1. Wiring lines and insulating layers are not shown in FIG. 2.

As illustrated in FIG. 1 to FIG. 6, a temperature sensor device in accordance with aspects of the present disclosure includes a substrate 110, a plurality of temperature sensors 120, a plurality of first common lines 130, and a plurality of second common lines 140.

First, the substrate 110 will be described. As illustrated in FIG. 2, in accordance with aspects of the present disclosure, the plurality of temperature sensors 120 are arranged on the substrate 110 and on a plurality of concentric virtual rings 121.

As illustrated in FIG. 2, the plurality of virtual rings 121 are spaced apart, extend alongside each other, and have a substantially circular ring shape. In other words, the plurality of virtual rings 121 have a C-shape. The plurality of virtual rings 121 may have a substantially elliptical ring shape or a substantially rectangular ring shape. Although the plurality of virtual rings 121 are equally spaced apart in one aspect of the disclosure, the distance between adjacent ones of the virtual rings 121 may vary.

In accordance with aspects of the present disclosure, the plurality of virtual rings 121 may include three virtual rings, an innermost virtual ring 121a, an intermediate virtual ring 121b located outside the innermost virtual ring 121a in the radial direction, and an outermost virtual ring 121c located outside the intermediate virtual ring 121b in the radial direction. The plurality of virtual rings 121 may include only two virtual rings, and the intermediate virtual ring 121b may be omitted. The plurality of virtual rings 121 may include four or more virtual rings, including two or more intermediate virtual rings 121b.

As illustrated in FIG. 1 and FIG. 2, the substrate 110 has an opening 111 in the center of the plurality of virtual rings 121. The edge of the opening 111 is located along the plurality of virtual rings 121. Specifically, the edge of the opening 111 is located along and on an inner side of the innermost virtual ring 121a. The edge of the opening 111 has a substantially circular shape. The substrate 110 does not necessarily need to have the opening 111. Instead of the opening 111, the substrate 110 may have a recess that can accommodate a heat source in the center of the plurality of virtual rings 121.

In accordance with aspects of the present disclosure, a notch 112 may be provided which extends from the outer edge of the substrate 110 and communicates with the opening 111. As illustrated in FIG. 1, in the substrate 110, the notch 112 is in a non-wiring region where none of a plurality of first common lines 130 and none of a plurality of second common lines 140 are present. For example, the substrate 110 includes a non-wiring region extending from the outer edge of the substrate 110 to the opening 111 and having none of the plurality of first common lines 130 and none of the plurality of second common lines 140 located therein.

The width and the shape of the notch 112 are not particularly limited, as long as they allow insertion of a heat-source holder from the outer edge of the substrate 110 through the notch 112 into the opening 111. For improved accuracy in measurement by the temperature sensor device 100, the notch 112 preferably has a width that is smaller than an average distance between adjacent ones of the plurality of temperature sensors 120 on the plurality of virtual rings 121.

The outer shape of the substrate 110 is not particularly limited. As illustrated in FIG. 1 and FIG. 2, the substrate 110 has a substantially circular outer shape that is along the plurality of virtual rings 121. The substrate 110 has an extended portion 113 that extends outward from the outer edge of the substantially circular shape. The extended portion 113 is located opposite the notch 112, with respect to the opening 111 in the center of the substrate 110.

A material used to make the substrate 110 is not particularly limited, as long as it is an insulating material. In accordance with aspects of the present disclosure, the substrate 110 is made of a material including at least one resin selected from a group of polyethylene terephthalate (PET), polyethylene naphthalate (PEN), polyimide (PI), and thermoplastic polyurethane (TPU).

The thickness of the substrate 110 is not particularly limited, but is preferably a thickness that allows the substrate 110 to be flexible. In accordance with aspects of the present disclosure, the substrate 110 is flexible.

As illustrated in FIG. 2, the plurality of temperature sensors 120 are disposed on the substrate 110 and spaced from each other on the plurality of concentric virtual rings 121. The adjacent ones of the plurality of temperature sensors 120 on the same virtual ring 121 may be substantially equally spaced apart. The temperature sensor device 100 may include additional temperature sensors 120 that are not located on the plurality of virtual rings 121.

In accordance with aspects of the present disclosure, eight temperature sensors 120 may be arranged on the innermost virtual ring 121a. The number of temperature sensors 120 arranged on the innermost virtual ring 121a is not limited to this. For example, the number of temperature sensors 120 arranged on the innermost virtual ring 121a is greater than or equal to 2 and less than or equal to 32.

In accordance with aspects of the present disclosure, 16 temperature sensors 120 may be arranged on the intermediate virtual ring 121b. The number of temperature sensors 120 arranged on the intermediate virtual ring 121b is not limited to this. For example, the number of temperature sensors 120 arranged on the intermediate virtual ring 121b is greater than or equal to 4 and less than or equal to 64.

In accordance with aspects of the present disclosure, 24 temperature sensors 120 are arranged on the outermost virtual ring 121c. The number of temperature sensors 120 arranged on the outermost virtual ring 121c is not limited to this. For example, the number of temperature sensors 120 arranged on the outermost virtual ring 121c is greater than or equal to 6 and less than or equal to 96.

The number of temperature sensors 120 located on an outer one of the plurality of virtual rings 121 is greater than the number of temperature sensors 120 located on an inner one of the plurality of virtual rings 121. In one aspect of the disclosure, the number of temperature sensors 120 located on the outermost virtual ring 121c is greater than the number of temperature sensors 120 located on the intermediate virtual ring 121b. The number of temperature sensors 120 located on the intermediate virtual ring 121b is greater than the number of temperature sensors 120 located on the innermost virtual ring 121a.

The plurality of temperature sensors 120 are not limited to a specific type. In one aspect of the disclosure, the plurality of temperature sensors 120 are thermistors. The thermistors are made of an oxide containing such an element as manganese (Mn), nickel (Ni), or cobalt (Co).

As illustrated in FIG. 1 and FIG. 3 to FIG. 6, the plurality of first common lines 130 are connected to the plurality of temperature sensors 120 from the outer side of the plurality of virtual rings 121. The plurality of first common lines 130 are each connected to corresponding ones of the plurality of temperature sensors 120.

The number of the plurality of first common lines 130 is not particularly limited and may be changed as appropriate, in accordance with the number of the plurality of temperature sensors 120 and the number of the plurality of virtual rings 121. As illustrated in FIG. 1 and FIG. 3 to FIG. 6, the temperature sensor device 100 according to one aspect of the disclosure, includes four first common lines 130. In another aspect of the disclosure, the four first common lines 130 include a first common line 130A, a first common line 130B, a first common line 130C, and a first common line 130D.

As illustrated in FIG. 1 and FIG. 3 to FIG. 6, the plurality of first common lines 130 each include a first annular line portion 131, first connection line portions 132, and a first extended line portion 133. The first annular line portions 131 are located along the plurality of virtual rings 121. The first annular line portion 131 of each of the plurality of first common lines 130 is located on the outer side of the plurality of virtual rings 121.

In one aspect of the disclosure, a first annular line portion 131A of the first common line 130A is located along the outermost virtual ring 121c, which is the outermost one of the plurality of virtual rings 121 in the radial direction, on the outer side of the outermost virtual ring 121c in the radial direction. A first annular line portion 131B of the first common line 130B is located along the first annular line portion 131A, on the outer side of the first annular line portion 131A in the radial direction. A first annular line portion 131C of the first common line 130C is located along the first annular line portion 131B, on the outer side of the first annular line portion 131B in the radial direction. A first annular line portion 131D of the first common line 130D is located along the first annular line portion 131C, on the outer side of the first annular line portion 131C in the radial direction.

The first connection line portions 132 each connect the first annular line portion 131 to at least one of the plurality of temperature sensors 120. For example, the first connection line portions 132 connect the first annular line portions 131 to corresponding ones of the plurality of temperature sensors 120. In one aspect of the disclosure, some of the plurality of first connection line portions 132 may have a branch line. This allows connection of one first annular line portion 131 to corresponding ones of the plurality of temperature sensors 120. Without having a branch line, all the first connection line portions 132 may be configured to connect one first annular line portion 131 to a corresponding one of the temperature sensors 120.

The first connection line portions 132 connect the first annular line portions 131 to corresponding ones of the plurality of temperature sensors 120 from the outer side of the plurality of virtual rings 121. The arrangement of the first connection line portions 132 is not particularly limited, as long as the first connection line portions 132 are arranged to connect to the temperature sensors 120 from the outer side of the plurality of virtual rings 121.

The plurality of first extended line portions 133 are each connected, from the outer side of the plurality of first annular line portions 131, to a corresponding one of the first annular line portions 131 and extended onto the extended portion 113 of the substrate 110. The plurality of first extended line portions 133 are each connected to an intermediate point of the corresponding one of the first annular line portions 131.

In one aspect of the disclosure, a first extended line portion 133A is connected to the first annular line portion 131A, a first extended line portion 133B is connected to the first annular line portion 131B, a first extended line portion 133C is connected to the first annular line portion 131C, and a first extended line portion 133D is connected to the first annular line portion 131D.

The plurality of first extended line portions 133 are each connected at one end thereof to the first annular line portion 131 and connected at the other end thereof to a power supply circuit and a current measuring circuit, which are not shown.

The first common lines 130 may be made of a conductive material, such as a material containing Ag. The first common lines 130 are formed by solidifying a conductive paste containing Ag.

As illustrated in FIG. 1 and FIG. 3 to FIG. 6, the plurality of second common lines 140 are connected to the plurality of temperature sensors 120 from the inner side of the plurality of virtual rings 121. The plurality of second common lines 140 are each connected to corresponding ones of the plurality of temperature sensors 120.

The number of the plurality of second common lines 140 is not particularly limited and may be changed as appropriate, in accordance with the number of the plurality of temperature sensors 120 and the number of the plurality of virtual rings 121. As illustrated in FIG. 1 and FIG. 3 to FIG. 6, the temperature sensor device 100 according to aspect of the disclosure includes 12 second common lines 140. In one aspect of the disclosure, the 12 second common lines 140 include a second common line 140a, a second common line 140b, a second common line 140c, a second common line 140d, a second common line 140e, a second common line 140f, a second common line 140g, a second common line 140h, a second common line 140i, a second common line 140j, a second common line 140k, and a second common line 140l.

The plurality of second common lines 140 each include a second annular line portion 141, second connection line portions 142, and a second extended line portion 143. The second annular line portions 141 are located along the plurality of virtual rings 121. In one aspect of the disclosure, the second annular line portion 141 of each of the plurality of second common lines 140 is located along and on an inner side of one of plurality of virtual rings 121 where temperature sensors 120 to which the second annular line portion 141 is connected are located. For example, the second annular line portion 141 of each of the plurality of second common lines 140 is located along and on the inner side of one of the plurality of virtual rings 121 where corresponding ones of the plurality of temperature sensors 120 are located.

In one aspect of the disclosure, a second annular line portion 141f of the second common line 140f and a second annular line portion 141g of the second common line 140g are each located along and on the inner side of the innermost virtual ring 121a on which corresponding ones of the plurality of temperature sensors 120 are located. A second annular line portion 141d of the second common line 140d, a second annular line portion 141e of the second common line 140e, a second annular line portion 141h of the second common line 140h, and a second annular line portion 141i of the second common line 140i are each located along and on an inner side of the intermediate virtual ring 121b on which corresponding ones of the plurality of temperature sensors 120 are located. A second annular line portion 141a of the second common line 140a, a second annular line portion 141b of the second common line 140b, a second annular line portion 141c of the second common line 140c, a second annular line portion 141j of the second common line 140j, a second annular line portion 141k of the second common line 140k, and a second annular line portion 141l of the second common line 140l are each located along and on the inner side of the outermost virtual ring 121c on which corresponding ones of the plurality of temperature sensors 120 are located.

The second connection line portions 142 each connect the second annular line portion 141 to at least one of the plurality of temperature sensors 120. For example, the second connection line portions 142 connect the second annular line portions 141 to corresponding ones of the plurality of temperature sensors 120. In one aspect of the disclosure, the second connection line portions 142 each have no branch line, and connect one second annular line portion 141 to one temperature sensor 120. The plurality of second connection line portions 142 each intersect none of the other lines.

The plurality of second extended line portions 143 are each connected, from the outer side of the plurality of second annular line portions 141, to a corresponding one of the second annular line portions 141 and extended onto the extended portion 113 of the substrate 110. The plurality of second extended line portions 143 are each connected to an end of the corresponding one of the second annular line portions 141.

In one aspect of the disclosure, a second extended line portion 143a is connected to the second annular line portion 141a, a second extended line portion 143b is connected to the second annular line portion 141b, a second extended line portion 143c is connected to the second annular line portion 141c, a second extended line portion 143d is connected to the second annular line portion 141d, a second extended line portion 143e is connected to the second annular line portion 141e, and a second extended line portion 143f is connected to the second annular line portion 141f In one aspect of the disclosure, the second annular line portions 141a to 141f each extend along the plurality of virtual rings 121 in one circumferential direction from the point of connection with the second extended line portion 143.

A second extended line portion 143g is connected to the second annular line portion 141g, a second extended line portion 143h is connected to the second annular line portion 141h, a second extended line portion 143i is connected to the second annular line portion 141i, a second extended line portion 143j is connected to the second annular line portion 141j, a second extended line portion 143k is connected to the second annular line portion 141k, and a second extended line portion 143l is connected to the second annular line portion 141l. In one aspect of the disclosure, the second annular line portions 141g to 141l each extend along a corresponding one of the virtual rings 121 in the other circumferential direction from the point of connection with the second extended line portion 143. For example, the second annular line portions 141g to 141l each extend from the point of connection with the second extended line portion 143 in a direction circumferentially opposite the second annular line portions 141a to 141f

The plurality of second extended line portions 143 are each connected at one end thereof to the second annular line portion 141 and connected at the other end thereof to the power supply circuit and the current measuring circuit, which are not shown.

The second common lines 140 may be made of a conductive material, such as a material containing Ag. The second common lines 140 are formed by solidifying a conductive paste containing Ag.

The plurality of temperature sensors 120 are each connected to one of the plurality of first common lines 130 and one of the plurality of second common lines 140 in such a manner as to form a unique combination. For example, the plurality of temperature sensors 120 are each connected to a corresponding one of the plurality of first common lines 130 and a corresponding one of the plurality of second common lines 140. The following describes how, in one aspect of the disclosure, the plurality of temperature sensors 120 are connected to the plurality of first common lines 130 and the plurality of second common lines 140.

As illustrated in FIG. 3, a temperature sensor Aa is connected through the corresponding first connection line portion 132 to the first annular line portion 131A, and connected through the corresponding second connection line portion 142 to the second annular line portion 141a. A temperature sensor Ad is connected through the corresponding first connection line portion 132 to the first annular line portion 131A, and connected through the corresponding second connection line portion 142 to the second annular line portion 141d. A temperature sensor Af is connected through the corresponding first connection line portion 132 to the first annular line portion 131A, and connected through the corresponding second connection line portion 142 to the second annular line portion 141f.

As illustrated in FIG. 3, a temperature sensor Ba is connected through the corresponding first connection line portion 132 to the first annular line portion 131B, and connected through the corresponding second connection line portion 142 to the second annular line portion 141a. A temperature sensor Bd is connected through the corresponding first connection line portion 132 to the first annular line portion 131B, and connected through the corresponding second connection line portion 142 to the second annular line portion 141d. A temperature sensor Bf is connected through the corresponding first connection line portion 132 to the first annular line portion 131B, and connected through the corresponding second connection line portion 142 to the second annular line portion 141f.

As illustrated in FIG. 3, a temperature sensor Ca is connected through the corresponding first connection line portion 132 to the first annular line portion 131C, and connected through the corresponding second connection line portion 142 to the second annular line portion 141a. A temperature sensor Cd is connected through the corresponding first connection line portion 132 to the first annular line portion 131C, and connected through the corresponding second connection line portion 142 to the second annular line portion 141d.

As illustrated in FIG. 3, a temperature sensor Da is connected through the corresponding first connection line portion 132 to the first annular line portion 131D, and connected through the corresponding second connection line portion 142 to the second annular line portion 141a. A temperature sensor Dd is connected through the corresponding first connection line portion 132 to the first annular line portion 131D, and connected through the corresponding second connection line portion 142 to the second annular line portion 141d.

As illustrated in FIG. 3, a temperature sensor Ab is connected through the corresponding first connection line portion 132 to the first annular line portion 131A, and connected through the corresponding second connection line portion 142 to the second annular line portion 141b. A temperature sensor Bb is connected through the corresponding first connection line portion 132 to the first annular line portion 131B, and connected through the corresponding second connection line portion 142 to the second annular line portion 141b.

As illustrated in FIG. 4, a temperature sensor Cb is connected through the corresponding first connection line portion 132 to the first annular line portion 131C, and connected through the corresponding second connection line portion 142 to the second annular line portion 141b. A temperature sensor Db is connected through the corresponding first connection line portion 132 to the first annular line portion 131D, and connected through the corresponding second connection line portion 142 to the second annular line portion 141b.

As illustrated in FIG. 4, a temperature sensor Ac is connected through the corresponding first connection line portion 132 to the first annular line portion 131A, and connected through the corresponding second connection line portion 142 to the second annular line portion 141c. A temperature sensor Ae is connected through the corresponding first connection line portion 132 to the first annular line portion 131A, and connected through the corresponding second connection line portion 142 to the second annular line portion 141e.

As illustrated in FIG. 4, a temperature sensor Bc is connected through the corresponding first connection line portion 132 to the first annular line portion 131B, and connected through the corresponding second connection line portion 142 to the second annular line portion 141c. A temperature sensor Be is connected through the corresponding first connection line portion 132 to the first annular line portion 131B, and connected through the corresponding second connection line portion 142 to the second annular line portion 141e.

As illustrated in FIG. 4, a temperature sensor Cc is connected through the corresponding first connection line portion 132 to the first annular line portion 131C, and connected through the corresponding second connection line portion 142 to the second annular line portion 141c. A temperature sensor Ce is connected through the corresponding first connection line portion 132 to the first annular line portion 131C, and connected through the corresponding second connection line portion 142 to the second annular line portion 141e. A temperature sensor Cf is connected through the corresponding first connection line portion 132 to the first annular line portion 131C, and connected through the corresponding second connection line portion 142 to the second annular line portion 141f.

As illustrated in FIG. 4, a temperature sensor Dc is connected through the corresponding first connection line portion 132 to the first annular line portion 131D, and connected through the corresponding second connection line portion 142 to the second annular line portion 141c. A temperature sensor De is connected through the corresponding first connection line portion 132 to the first annular line portion 131D, and connected through the corresponding second connection line portion 142 to the second annular line portion 141e. A temperature sensor Df is connected through the corresponding first connection line portion 132 to the first annular line portion 131D, and connected through the corresponding second connection line portion 142 to the second annular line portion 141f.

As illustrated in FIG. 5, a temperature sensor Al is connected through the corresponding first connection line portion 132 to the first annular line portion 131A, and connected through the corresponding second connection line portion 142 to the second annular line portion 141l. A temperature sensor Ai is connected through the corresponding first connection line portion 132 to the first annular line portion 131A, and connected through the corresponding second connection line portion 142 to the second annular line portion 141i. A temperature sensor Ag is connected through the corresponding first connection line portion 132 to the first annular line portion 131A, and connected through the corresponding second connection line portion 142 to the second annular line portion 141g.

As illustrated in FIG. 5, a temperature sensor Bl is connected through the corresponding first connection line portion 132 to the first annular line portion 131B, and connected through the corresponding second connection line portion 142 to the second annular line portion 141l. A temperature sensor Bi is connected through the corresponding first connection line portion 132 to the first annular line portion 131B, and connected through the corresponding second connection line portion 142 to the second annular line portion 141i. A temperature sensor Bg is connected through the corresponding first connection line portion 132 to the first annular line portion 131B, and connected through the corresponding second connection line portion 142 to the second annular line portion 141g.

As illustrated in FIG. 5, a temperature sensor Cl is connected through the corresponding first connection line portion 132 to the first annular line portion 131C, and connected through the corresponding second connection line portion 142 to the second annular line portion 141l. A temperature sensor Ci is connected through the corresponding first connection line portion 132 to the first annular line portion 131C, and connected through the corresponding second connection line portion 142 to the second annular line portion 141i.

As illustrated in FIG. 5, a temperature sensor Dl is connected through the corresponding first connection line portion 132 to the first annular line portion 131D, and connected through the corresponding second connection line portion 142 to the second annular line portion 141l. A temperature sensor Di is connected through the corresponding first connection line portion 132 to the first annular line portion 131D, and connected through the corresponding second connection line portion 142 to the second annular line portion 141i.

As illustrated in FIG. 5, a temperature sensor Ak is connected through the corresponding first connection line portion 132 to the first annular line portion 131A, and connected through the corresponding second connection line portion 142 to the second annular line portion 141k. A temperature sensor Bk is connected through the corresponding first connection line portion 132 to the first annular line portion 131B, and connected through the corresponding second connection line portion 142 to the second annular line portion 141k.

As illustrated in FIG. 6, a temperature sensor Ck is connected through the corresponding first connection line portion 132 to the first annular line portion 131C, and connected through the corresponding second connection line portion 142 to the second annular line portion 141k. A temperature sensor Dk is connected through the corresponding first connection line portion 132 to the first annular line portion 131D, and connected through the corresponding second connection line portion 142 to the second annular line portion 141k.

As illustrated in FIG. 6, a temperature sensor Aj is connected through the corresponding first connection line portion 132 to the first annular line portion 131A, and connected through the corresponding second connection line portion 142 to the second annular line portion 141j. A temperature sensor Ah is connected through the corresponding first connection line portion 132 to the first annular line portion 131A, and connected through the corresponding second connection line portion 142 to the second annular line portion 141h.

As illustrated in FIG. 6, a temperature sensor Bj is connected through the corresponding first connection line portion 132 to the first annular line portion 131B, and connected through the corresponding second connection line portion 142 to the second annular line portion 141j. A temperature sensor Bh is connected through the corresponding first connection line portion 132 to the first annular line portion 131B, and connected through the corresponding second connection line portion 142 to the second annular line portion 141h.

As illustrated in FIG. 6, a temperature sensor Cj is connected through the corresponding first connection line portion 132 to the first annular line portion 131C, and connected through the corresponding second connection line portion 142 to the second annular line portion 141j. A temperature sensor Ch is connected through the corresponding first connection line portion 132 to the first annular line portion 131C, and connected through the corresponding second connection line portion 142 to the second annular line portion 141h. A temperature sensor Cg is connected through the corresponding first connection line portion 132 to the first annular line portion 131C, and connected through the corresponding second connection line portion 142 to the second annular line portion 141g.

As illustrated in FIG. 6, a temperature sensor Dj is connected through the corresponding first connection line portion 132 to the first annular line portion 131D, and connected through the corresponding second connection line portion 142 to the second annular line portion 141j. A temperature sensor Dh is connected through the corresponding first connection line portion 132 to the first annular line portion 131D, and connected through the corresponding second connection line portion 142 to the second annular line portion 141h. A temperature sensor Dg is connected through the corresponding first connection line portion 132 to the first annular line portion 131D, and connected through the corresponding second connection line portion 142 to the second annular line portion 141g.

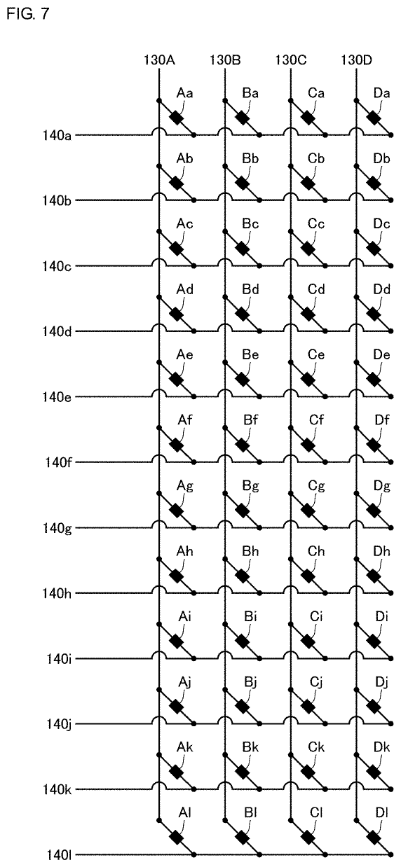

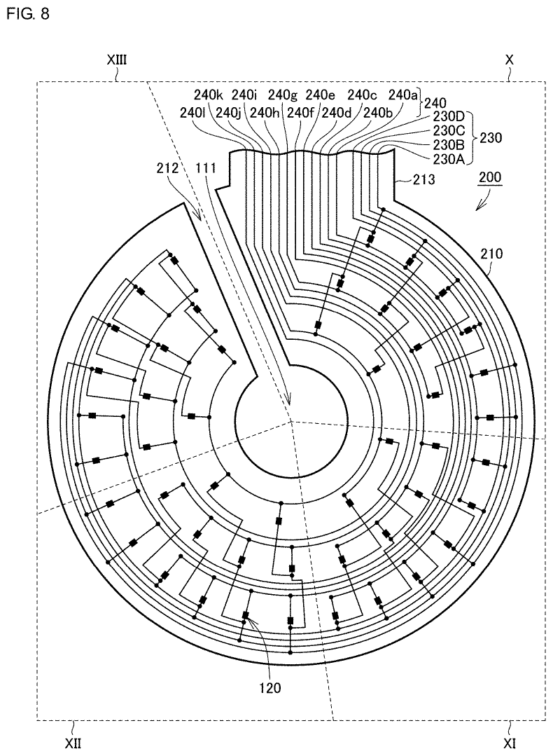

As described above, the plurality of temperature sensors 120 according to one aspect of the disclosure are connected in a one-to-one correspondence to combinations of the first common line 130 and the second common line 140. FIG. 7 is a circuit diagram illustrating how a plurality of temperature sensors are each electrically connected to one of a plurality of first common lines and one of a plurality of second common lines in the temperature sensor device according to aspects of the present disclosure.

As illustrated in FIG. 7, the plurality of temperature sensors 120 are electrically connected to the plurality of first common lines 130 and the plurality of second common lines 140 so as to form a matrix.

In one aspect of the disclosure, some of the plurality of first connection line portions 132 may have a branch line. This reduces the number of areas where the first connection line portions 132 intersect the second annular line portions 141.

As illustrated in FIG. 1 and FIG. 3 to FIG. 6, the temperature sensor device 100 according to an aspect of the disclosure further includes a plurality of insulating layers 150. When a plurality of lines intersect without being electrically connected each other, the insulating layers 150 are each disposed between the plurality of lines in the area of intersection.

As illustrated in FIG. 3, there is an area where more than one of the plurality of first annular line portions 131 intersect non-corresponding ones of the first extended line portions 133. In the area of intersection, the insulating layer 150 is disposed between the first annular line portions 131 and the non-corresponding ones of the first extended line portions 133. In one aspect of the disclosure, the first extended line portions 133 are disposed on one side of the insulating layer 150 adjacent to the substrate 110, and the first annular line portions 131 are disposed on the other side of the insulating layer 150 remote from the substrate 110. The positional relation between the lines in the area of intersection, described above, may be reversed.

As illustrated in FIG. 3 and FIG. 5, there is an area where the plurality of first annular line portions 131 intersect the plurality of second extended line portions 143. In the area of intersection, the insulating layer 150 is disposed between the plurality of first annular line portions 131 and the plurality of second extended line portions 143. In one aspect of the disclosure, the second extended line portions 143 are disposed on one side of the insulating layer 150 adjacent to the substrate 110, and the first annular line portions 131 are disposed on the other side of the insulating layer 150 remote from the substrate 110. The positional relation between the lines in the area of intersection, described above, may be reversed.

As illustrated in FIG. 3 to FIG. 6, there are areas where one or more of the plurality of first annular line portions 131 intersect a non-corresponding one of the first connection line portions 132. In each area of intersection, the insulating layer 150 is disposed between the one or more of the plurality of first annular line portions 131 and the non-corresponding one of the first connection line portions 132. In one aspect of the disclosure, the first connection line portion 132 is disposed on one side of the insulating layer 150 adjacent to the substrate 110, and the one or more of the plurality of first annular line portions 131 are disposed on the other side of the insulating layer 150 remote from the substrate 110. The positional relation of the lines with respect to the insulating layer 150 in the area of intersection, described above, may be reversed.

In one aspect of the disclosure, there are areas where one of the plurality of first connection line portions 132 intersect one or more of the second annular line portions 141. In each area of intersection, the insulating layer 150 is disposed between the first connection line portion 132 and the one or more of the second annular line portions 141. In one aspect of the disclosure, the one or more of second annular line portions 141 are disposed on one side of the insulating layer 150 adjacent to the substrate 110, and the first connection line portion 132 is disposed on the other side of the insulating layer 150 remote from the substrate 110. The positional relation of the lines with respect to the insulating layer 150 in the area of intersection, described above, may be reversed.

For reinforcement of lines, additional insulating layers 150 may be provided on lines outside the areas where the plurality of lines intersect each other as described above.

The temperature sensor device 100 may include a protective layer for insulating and protecting lines from the outside environment. The protective layer is disposed to cover the plurality of first common lines 130 and the plurality of second common lines 140.

A method for manufacturing the temperature sensor device according to aspects of the present disclosure are described below.

First, a lower-side wiring part is formed on the substrate 110. In one aspect of the disclosure, the lower-side wiring part includes part of the first connection line portions 132 located outside the outermost virtual ring 121c, the first extended line portions 133, the second annular line portions 141, the second connection line portions 142, and the second extended line portion 143.

In one aspect of the disclosure, for low-cost production of the temperature sensor device 100, the lower-side wiring part is formed by applying a silver paste to the substrate 110 to print a desired pattern shape thereon, and then solidifying the silver paste with heat or ultraviolet light. The lower-side wiring part may be formed by an inkjet method, or may be formed by etching after photolithographic patterning.

Next, the insulating layers 150 are printed by applying an insulating material. The insulating layers 150 may be formed by an inkjet method, or may be formed by a dispensing method.

Next, an upper-side wiring part is formed. In one aspect of the disclosure, the upper-side wiring part includes the first annular line portions 131 and the rest of the first connection line portions 132, not included in the lower-side wiring part.

In one aspect of the disclosure, for low-cost production of the temperature sensor device 100, the upper-side wiring part is formed by applying a silver paste to the substrate 110 having the lower-side wiring part and the insulating layers 150 thereon to print a desired pattern shape, and then solidifying the silver paste with heat or ultraviolet light. The upper-side wiring part may be formed by an inkjet method, or may be formed by etching after photolithographic patterning.

Next, the temperature sensors 120 are added onto the substrate 110. The temperature sensors 120 may be formed on the substrate 110 by applying thereto a material for forming the temperature sensors 120 through solder printing or reflow heating. Alternatively, the temperature sensors 120 prepared in advance may be mounted on the substrate 110. For mounting the temperature sensors 120 on the substrate 110, the temperature sensors 120 may be secured in place with a bonding agent that is formed, for example, by solder or conductive adhesive. In this case, the solder may be melted by laser irradiation or microwave heating.

The temperature sensor device 100 according to aspects of the present disclosure, such as that illustrated in FIG. 1, is manufactured by the process described above. The combination of lines included in each of the lower-side wiring part and the upper-side wiring part is not particularly limited, as long as the insulating layers 150 can be disposed between a plurality of lines intersecting each other.

As described above, in the temperature sensor device 100 according to one aspect of the disclosure, the plurality of temperature sensors 120 are spaced from each other on the plurality of concentric virtual rings 121, and the first annular line portions 131 of the plurality of first common lines 130 are located on the outer side of the plurality of virtual rings 121. For example, the plurality of first common lines 130 are absent in the center where the heat source is located. This allows the temperature sensors 120 to be arranged close to the center where the heat source is placed, and thus enables accurate measurement of a concentric temperature distribution.

In the temperature sensor device 100 according to one aspect of the disclosure, the second annular line portions 141 of the plurality of second common lines 140 are each located along and on the inner side of a corresponding one of the plurality of virtual rings 121 where a plurality of temperature sensors 120 to which the second annular line portion 141 is connected is located. For example, the plurality of second common lines 140 are absent in the center where the heat source is located. This allows the plurality of temperature sensors 120 on the innermost virtual ring 121a of the plurality of virtual rings 121 to be arranged closer to the center where the heat source is placed, and thus enables accurate measurement of a concentric temperature distribution. It is also possible to achieve improved responsiveness of the temperature sensor device 100 to temperature changes caused by heat from the heat source.

The substrate 110 is flexible in the temperature sensor device 100 according to one aspect of the disclosure. Therefore, by positioning the substrate 110 along a non-flat surface, such as a curved surface, the temperature sensor device 100 can measure a temperature distribution within the non-flat surface.

In the temperature sensor device 100 according to one aspect of the disclosure, the number of temperature sensors 120 located on an outer one of the plurality of virtual rings 121 is greater than the number of temperature sensors 120 located on an inner one of the plurality of virtual rings 121. Accordingly, the circumferential distance between adjacent ones of the plurality of temperature sensors 120 located on the virtual ring 121 on the outer side can be made closer to the circumferential distance between adjacent ones of the plurality of temperature sensors 120 located on the virtual ring 121 on the inner side. This enables accurate measurement of a concentric temperature distribution.

In the temperature sensor device 100 according to one aspect of the disclosure, the substrate 110 has the opening 111 in the center of the plurality of virtual rings 121. Therefore, when a heat-source holder extends perpendicularly to the direction in which the temperature distribution spreads, the temperature distribution that originates from the heat source can be measured by inserting the heat-source holder into the opening 111.

In the temperature sensor device 100 according to one aspect of the disclosure, the substrate 110 includes a non-wiring region that extends from the outer edge of the substrate 110 to the opening 111 and has none of the plurality of first common lines 130 and none of the plurality of second common lines 140 located therein. This allows lines for the heat source to be connected to the heat source in the opening 111 in such a manner as to extend from outside the outer edge of the substrate 110 over the non-wiring region. Errors in measurement by the temperature sensor device 100, resulting from the effect of lines for the heat source, can thus be reduced.

In the temperature sensor device 100 according to one aspect of the disclosure, the non-wiring region of the substrate 110 has the notch 112 that extends from the outer edge of the substrate 110 and communicates with the opening 111. Therefore, when a heat-source holder extends perpendicularly to the direction in which the temperature distribution spreads, the heat-source holder can be inserted from outside the outer edge of the substrate 110 through the notch 112 into the opening 111. This facilitates placement of the heat source in the opening 111.

In the temperature sensor device 100 according to one aspect of the disclosure, the plurality of temperature sensors 120 are thermistors. The temperature sensor device 100 with high measurement accuracy can thus be manufactured at low cost.

A temperature sensor device according to aspects of the present disclosure will be described below with reference to the drawings. The temperature sensor device according to one aspect of the disclosure differs from the temperature sensor device 100 described above primarily in the arrangement of the first common lines and the second common lines. The description of configurations that are similar to those of the temperature sensor device 100 described above will not be repeated.

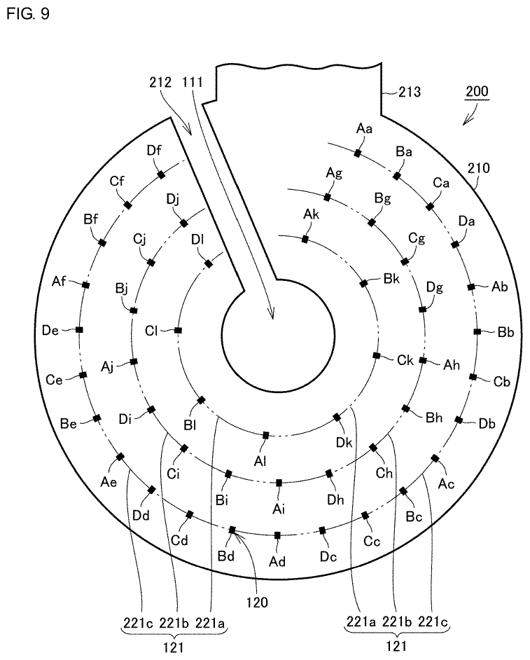

FIG. 8 is a plan view of a temperature sensor device according to one aspect of the disclosure. FIG. 9 is a plan view illustrating an arrangement of temperature sensors in the temperature sensor device illustrated in FIG. 8. FIG. 10 is an enlarged plan view of region X surrounded by a dotted line in the temperature sensor device illustrated in FIG. 8. FIG. 11 is an enlarged plan view of region XI surrounded by a dotted line in the temperature sensor device illustrated in FIG. 8. FIG. 12 is an enlarged plan view of region XII surrounded by a dotted line in the temperature sensor device illustrated in FIG. 8. FIG. 13 is an enlarged plan view of region XIII surrounded by a dotted line in the temperature sensor device illustrated in FIG. 8. Although no insulating layers are shown in FIG. 8 to FIG. 13, the temperature sensor device according to one aspect of the disclosure includes, in the areas where lines intersect, insulating layers that are similar to the insulating layers 150 of the temperature sensor device 100 according to one aspect of the disclosure.

As illustrated in FIG. 8 and FIG. 9, in a temperature sensor device 200, an extended portion 213 is located adjacent to a notch 212 in the circumferential direction of the plurality of virtual rings 121.

As illustrated in FIG. 8 to FIG. 13, a first annular line portion 231D of a first common line 230D is disposed closest of a plurality of first common lines 230 to the center of the plurality of virtual rings 121, and is located along an outermost virtual ring 221c. A first annular line portion 231C of a first common line 230C is located along the first annular line portion 231D, on the outer side of the first annular line portion 231D in the radial direction. A first annular line portion 231B of a first common line 230B is located along the first annular line portion 231C, on the outer side of the first annular line portion 231C in the radial direction. A first annular line portion 231A of a first common line 230A is located along the first annular line portion 231B, on the outer side of the first annular line portion 231B in the radial direction.

In one aspect of the disclosure, a plurality of first extended line portions 233 are each connected to an end of a corresponding one of the first annular line portions 231. For example, the first annular line portions 231A to 231D each extend along the outermost virtual ring 221c in one circumferential direction from the point of connection with the first extended line portion 233.

As illustrated in FIG. 8 and FIG. 10 to FIG. 13, a second annular line portion 241a of a second common line 240a, a second annular line portion 241b of a second common line 240b, a second annular line portion 241c of a second common line 240c, a second annular line portion 241d of a second common line 240d, a second annular line portion 241e of a second common line 240e, and a second annular line portion 241f of a second common line 240f are each located along and on an inner side of the outermost virtual ring 221c on which corresponding ones of the plurality of temperature sensors 120 are located.

A second annular line portion 241g of a second common line 240g, a second annular line portion 241h of a second common line 240h, a second annular line portion 241i of a second common line 240i, and a second annular line portion 241j of a second common line 240j are each located along and on an inner side of an intermediate virtual ring 221b on which corresponding ones of the plurality of temperature sensors 120 are located. A second annular line portion 241k of a second common line 240k and a second annular line portion 241l of a second common line 240l are each located along and on an inner side of an innermost virtual ring 221a on which corresponding ones of the plurality of temperature sensors 120 are located.

In one aspect of the disclosure, the second annular line portions 241a to 241l each extend in one circumferential direction from the point of connection with a corresponding one of second extended line portions 243. For example, the plurality of second annular line portions 241 extend in the same circumferential direction as the plurality of first annular line portions 231.

As illustrated in FIG. 10, in the temperature sensor device 200 according to one aspect of the disclosure, the plurality of first annular line portions 231 each do not intersect non-corresponding ones of the first extended line portions 233. Also, the plurality of first annular line portions 231 intersect none of the plurality of second extended line portions 243. This reduces the number of areas where a plurality of lines intersect, and improves reliability of the temperature sensor device 200 while facilitating the process of forming lines. When a substrate 210 is flexible, the extended line portions 233 and 243 of the temperature sensor device 200 have improved flexibility at extended ends thereof.

A temperature sensor device according to aspects of the present disclosure will be described below with reference to the drawings. The temperature sensor device according aspects of the present disclosure described above differs from the temperature sensor device 200 described above primarily in the arrangement of the first common lines and the second common lines. The description of configurations that are similar to those of the temperature sensor device 200 according to aspects described above will not be repeated.

FIG. 14 is a plan view of a temperature sensor device according to one aspect of the disclosure. FIG. 15 is a plan view illustrating an arrangement of temperature sensors in the temperature sensor device illustrated in FIG. 14. FIG. 16 is an enlarged plan view of region XVI surrounded by a dotted line in the temperature sensor device illustrated in FIG. 14. FIG. 17 is an enlarged plan view of region XVII surrounded by a dotted line in the temperature sensor device illustrated in FIG. 14. FIG. 18 is an enlarged plan view of region XVIII surrounded by a dotted line in the temperature sensor device illustrated in FIG. 14. FIG. 19 is an enlarged plan view of region XIX surrounded by a dotted line in the temperature sensor device illustrated in FIG. 14. Although no insulating layers are shown in FIG. 14 to FIG. 19, the temperature sensor device according to one aspect of the disclosure includes, in the areas where lines intersect, insulating layers that are similar to the insulating layers 150 of the temperature sensor device 100 according aspects of the present disclosure.

As illustrated in FIG. 14 and FIG. 15, in a temperature sensor device 300 according to one aspect of the disclosure, a substrate 310 does not have a notch. Also, the substrate 310 does not have a non-wiring region.

As illustrated in FIG. 14 and FIG. 16 to FIG. 19, a second annular line portion 341a of a second common line 340a and a second annular line portion 341b of a second common line 340b are each located along and on an inner side of an innermost virtual ring 321a on which corresponding ones of the plurality of temperature sensors 120 are located. A second annular line portion 341c of a second common line 340c, a second annular line portion 341d of a second common line 340d, a second annular line portion 341e of a second common line 340e, and a second annular line portion 341f of a second common line 340f are each located along and on an inner side of an intermediate virtual ring 321b on which corresponding ones of the plurality of temperature sensors 120 are located. A second annular line portion 341g of a second common line 340g, a second annular line portion 341h of a second common line 340h, a second annular line portion 341i of a second common line 340i, a second annular line portion 341j of a second common line 340j, a second annular line portion 341k of a second common line 340k, and a second annular line portion 341l of a second common line 340l are each located along and on an inner side of an outermost virtual ring 321c on which corresponding ones of the plurality of temperature sensors 120 are located.

In one aspect of the disclosure, the plurality of second annular line portions 341 extend in a direction circumferentially opposite a plurality of first annular line portions 331.

As illustrated in FIG. 16, in the temperature sensor device 300 according to one aspect of the disclosure, the plurality of first annular line portions 331 each do not intersect non-corresponding ones of first extended line portions 333. Also, as illustrated in FIG. 19, the plurality of first annular line portions 331 intersect none of a plurality of second extended line portions 343. This reduces the number of areas where a plurality of lines intersect, and improves reliability of the temperature sensor device 300 while facilitating the process of forming lines. When the substrate 310 is flexible, the extended line portions 333 and 343 of the temperature sensor device 300 have improved flexibility at extended ends thereof.

In the temperature sensor device 300 according to one aspect of the disclosure, the substrate 310 does not have a notch. This allows the temperature sensors 120 to be arranged throughout the perimeter of the heat source in the circumferential direction, and thus enables accurate measurement of temperature distribution that spreads concentrically from the heat source.

Of the configurations described above, those capable of being combined may be combined together.

The description of the aspects disclosed should be considered as being illustrative in all respects and not being restrictive. The scope of the present invention is shown by the claims rather than by the above description, and is intended to include meanings equivalent to the claims and all changes in the scope. While preferred aspects of the invention have been described above, it is to be understood that variations and modifications will be apparent to those skilled in the art without departing from the scope and spirit of the invention.

### DESCRIPTION OF REFERENCE SYMBOLS

100, 200, 300: temperature sensor device, 110, 210, 310: substrate, 111: opening, 112, 212: notch, 113, 213: extended portion, 120, Aa, Ab, Ac, Ad, Ae, Af, Ag, Ah, Ai, Aj, Ak, Al, Ba, Bb, Bc, Bd, Be, Bf, Bg, Bh, Bi, Bj, Bk, Bl, Ca, Cb, Cc, Cd, Ce, Cf, Cg, Ch, Ci, Cj, Ck, Cl, Da, Db, Dc, Dd, De, Df, Dg, Dh, Di, Dj, Dk, Dl: temperature sensor, 121: virtual ring, 121a, 221a, 321a: innermost virtual ring, 121b, 221b, 321b: intermediate virtual ring, 121c, 221c, 321c: outermost virtual ring, 130, 130A, 130B, 130C, 130D, 230, 230A, 230B, 230C, 230D: first common line, 131, 131A, 131B, 131C, 131D, 231, 231A, 231B, 231C, 231D, 331: first annular line portion, 132: first connection line portion, 133, 133A, 133B, 133C, 133D, 233, 333: first extended line portion, 140, 140a, 140b, 140c, 140d, 140e, 140f, 140g, 140h, 140i, 140j, 140k, 140l, 240a, 240b, 240c, 240d, 240e, 240f, 240g, 240h, 240i, 240j, 240k, 240l, 340a, 340b, 340c, 340d, 340e, 340f, 340g, 340h, 340i, 340j, 340k, 340l: second common line, 141, 141a, 141b, 141c, 141d, 141e, 141f, 141g, 141h, 141i, 141j, 141k, 141l, 241, 241a, 241b, 241c, 241d, 241e, 241f, 241g, 241h, 241i, 241j, 241k, 241l, 341, 341a, 341b, 341c, 341d, 341e, 341f, 341g, 341h, 341i, 341j, 341k, 341l: second annular line portion, 142: second connection line portion, 143, 143a, 143b, 143c, 143d, 143e, 143f, 143g, 143h, 143i, 143j, 143k, 143l, 243, 343: second extended line portion, 150: insulating layer.

What is claimed is:

1. A temperature sensor device comprising:
a substrate;
a plurality of temperature sensors disposed on the substrate and positioned as concentric virtual rings;
a plurality of first common lines connected to the plurality of temperature sensors disposed on an outer side of the plurality of virtual rings; and
a plurality of second common lines connected to the plurality of temperature sensors disposed on an inner side of the plurality of virtual rings,
wherein each of the plurality of temperature sensors is connected to one of the plurality of first common lines and one of the plurality of second common lines.

2. The temperature sensor device according to claim 1, wherein each of the plurality of first common lines include a first annular line portion located along the plurality of virtual rings, and a first connection line portion connecting the first annular line portion to at least one of the plurality of temperature sensors.

3. The temperature sensor device according to claim 2, wherein the first annular line portion of each of the plurality of first common lines is positioned on the outer side of the plurality of virtual rings.

4. The temperature sensor device according to claim 1, wherein each of the plurality of second common lines include a second annular line portion located along the plurality of virtual rings, and a second connection line portion connecting the second annular line portion to at least one of the plurality of temperature sensors.

5. The temperature sensor device according to claim 4, wherein the second annular line portion of each of the plurality of second common lines is positioned on the inner side of one of the plurality of virtual rings, the one of the plurality of virtual rings being a virtual ring where the temperature sensor to which the second annular line portion is connected is positioned.

6. The temperature sensor device according to claim 1, wherein the substrate is flexible.

7. The temperature sensor device according to claim 1, wherein a number of the plurality of temperature sensors located on an outer ring of the plurality of virtual rings is greater than the number of the plurality temperature sensors located on an inner ring of the plurality of virtual rings.

8. The temperature sensor device according to claim 1, wherein the substrate has an opening in a center of the plurality of virtual rings.

9. The temperature sensor device according to claim 8, wherein the substrate includes a non-wiring region extending from an outer edge of the substrate to the opening, the non-wiring region being void of both the plurality of first common lines and the plurality of second common lines.

10. The temperature sensor device according to claim 9, wherein the non-wiring region of the substrate has a notch that extends from the outer edge of the substrate and communicates with the opening.

11. The temperature sensor device according to claim 1, wherein the plurality of temperature sensors are thermistors.

12. The temperature sensor device according to claim 11, wherein the thermistors includes at least one of manganese (Mn), nickel (Ni) or cobalt (Co).

13. A method of manufacturing a temperature sensor device comprising:
forming a first wiring part on a substrate;
applying insulating material configured to form insulating layers;
forming a second wiring part on the substrate; and
applying a plurality of temperature sensors on the substrate and positioned as concentric virtual rings;
wherein the first wiring part including a plurality of first common lines connected to the plurality of temperature sensors disposed on an outer side of the plurality of virtual rings and a plurality of second common lines connected to the plurality of temperature sensors disposed on an inner side of the plurality of virtual rings.

14. The method according to claim 13, wherein the substrate is flexible.

15. The method according to claim 13, wherein a number of the plurality of temperature sensors located on an outer ring of the plurality of virtual rings is greater than the number of the plurality temperature sensors located on an inner ring of the plurality of virtual rings.

16. The method according to claim 13, wherein the substrate has an opening in a center of the plurality of virtual rings.

17. The method according to claim 16, wherein the substrate includes a non-wiring region extending from an outer edge of the substrate to the opening, the non-wiring region being void of both the plurality of first common lines and the plurality of second common lines.

18. The method according to claim 17, wherein the non-wiring region of the substrate has a notch that extends from the outer edge of the substrate and communicates with the opening.

19. The method according to claim 13, wherein the plurality of temperature sensors are thermistors.

20. The method according to claim 19, wherein the thermistors includes at least one of manganese (Mn), nickel (Ni) or cobalt (Co).
